(19) United States
(12) Patent Application Publication
(10) Pub. No.: US 2026/0238568 A1
(43) Pub. Date: Aug. 13, 2026

(54) SYSTEM AND METHOD FOR COLLECTING NETWORK TRAFFIC DATA ON-DEMAND

(71) Applicant: ELECTRONICS AND TELECOMMUNICATIONS RESEARCH INSTITUTE, Daejeon (KR)

(72) Inventors: Chunglae CHO, Daejeon (KR); Seung Hyun YOON, Daejeon (KR)

(73) Assignee: ELECTRONICS AND TELECOMMUNICATIONS RESEARCH INSTITUTE, Daejeon (KR)

(21) Appl. No.: 19/280,703

(22) Filed: Jul. 25, 2025

(30) Foreign Application Priority Data
Feb. 11, 2025 (KR) 10-2025-0017215

(51) Int. Cl. H04L 43/02; H04W 24/08

(52) U.S. Cl. CPC H04L 43/02; H04W 24/08

(57) ABSTRACT

An embodiment of the present disclosure provides a method for collecting network traffic data on-demand. A data collection control unit transmits a collection order request to a data collection agent unit and a data processing agent unit. The data collection agent unit sends a first control signal to a network traffic mirroring device connected to a physical or virtual network, and receives first network traffic data. The data collection agent unit then transmits the collected data to a data collection processing platform. The data processing agent unit transmits a second control signal to the data collection processing platform, enabling the platform to perform data processing based on the collection order request. This method allows for flexible, user-specified collection of network traffic data in environments with both physical and virtual networks.

### CROSS-REFERENCE TO RELATED APPLICATION

The present application claims priority to Patent Application No. 10-2025-0017215, filed on in Korea Intellectual Property Office on Feb. 11, 2025, the entire contents of which are incorporated herein by reference.

### TECHNICAL FIELD

The present disclosure relates to a system and a method for collecting network traffic data on-demand.

### BACKGROUND

The description described below merely provides background information related to the present embodiment, and does not constitute the related art.

It is essential to collect network traffic data in order to perform network operation management such as performance analysis, anomaly detection, root cause analysis, and charging in a network environment in which a physical network and a virtual network are mixed. However, continuously collecting the entirety of large-scale network traffic data imposes a heavy load on the collection system and may incur high costs.

In addition, due to the diversity of network operation management services, the attribute information and statistical information of the network traffic data that needs to be collected, as well as the required collection time, may vary by service. In particular, some network operation management services are only activated upon the occurrence of specific events, making it efficient to collect the relevant traffic or statistical data only during their operation. Furthermore, the emergence of new types of network operation management services may give rise to additional network traffic and statistical data collection requirements.

### SUMMARY

The present disclosure provides a system and method for collecting physical or virtual network traffic data on-demand, limited to a period specified by the user, in a network environment where physical and virtual networks are mixed. The system extracts and stores only the data attribute or statistical information designated by the user, or performs the designated data processing and transmits the result to a data consumer.

The present disclosure provides a system and a method for collecting one or more network traffic data items from one or more physical networks or virtual networks simultaneously in one collection order.

The present disclosure provides a system and a method for transmitting one or more network traffic data or statistical information collected in one collection order to one or more different types of data consumers.

The problems to be solved by the present invention are not limited to the above-mentioned problems, and other problems that are not mentioned will be clearly understood by those skilled in the art from the following description.

An embodiment of the present disclosure provides a method for collecting network traffic data on-demand, including: transmitting, by a data collection control unit, a collection order request of a user to a data collection agent unit and a data processing agent unit; transmitting, by the data collection agent unit, a first control signal to a network traffic mirroring device according to the collection order request, and receiving first network traffic data from the network traffic mirroring device connected to a physical network or a virtual network; transmitting, by the data collection agent unit, the first network traffic data to a data collection processing platform; and transmitting, by the data processing agent unit, a second control signal to the data collection processing platform according to the collection order request, wherein the user receives second network traffic data that meets the collection order request from the data processing agent unit or the data collection processing platform, and wherein the collection order request includes collection period information desired by the user and data attribute information and statistical information specified by the user.

The data collection processing platform is configured to: upon receiving the second control signal from the data processing agent unit, process the stored first network traffic data to generate second network traffic data that meets the collection order request, and directly transmit the generated second network traffic data that meets the collection order request to the user.

The data processing agent unit is configured to read the first network traffic data stored in the data collection processing platform according to the collection order request, perform a data processing task on the read data, generate second network traffic data that meets the collection order request, and transmit the result to the user.

An embodiment of the present disclosure provides a system for collecting network traffic data on-demand, including: a data collection control unit configured to transmit a collection order request of a user to a data collection agent unit and a data processing agent unit; a data collection agent unit configured to transmit a first control signal to a network traffic mirroring device according to the collection order request, receive first network traffic data from the network traffic mirroring device connected to a physical network or a virtual network, and transmit the first network traffic data to a data collection processing platform; and a data processing agent unit configured to transmit a second control signal to the data collection processing platform according to the user's collection order request, wherein the user receives second network traffic data that meets the collection order request from the data processing agent unit or the data collection processing platform, and wherein the collection order request includes collection period information desired by the user and data attribute information and statistical information specified by the user.

The present disclosure may collect physical network traffic data or virtual network traffic data on-demand only for a period desired by a user in a network environment in which a physical network and a virtual network are mixed, extract and store only data attribute information or statistical information specified by the user, or perform data processing specified by the user and transmit the processed data to a data consumer.

The present disclosure may collect one or more network traffic data items from one or more physical networks or virtual networks simultaneously in one collection order.

The present disclosure may transmit one or more network traffic data or statistical information collected in one collection order to one or more data consumers of different types.

The effects of the present disclosure are not limited to the above-mentioned effects, and other effects that are not mentioned will be clearly understood by those skilled in the art from the following description.

### BRIEF DESCRIPTION OF THE DRAWINGS

FIG. 1 is a structural diagram of a system for collecting network traffic data on-demand according to an embodiment of the present disclosure.

FIG. 2 illustrates an example of information managed by a data collection control unit of a system for collecting network traffic data on-demand according to an embodiment of the present disclosure.

FIG. 3 is a diagram illustrating a configuration of a data collection agent unit of a system for collecting network traffic data on-demand according to an embodiment of the present disclosure.

FIG. 4 is a diagram illustrating a configuration of a data processing agent unit of a system for collecting network traffic data on-demand according to an embodiment of the present disclosure.

FIGS. 5 and 6 are flowcharts illustrating an on-demand data collection start procedure using a system for collecting network traffic data on-demand according to an embodiment of the present disclosure.

FIG. 7 is a flowchart illustrating an on-demand data collection interruption procedure using a system for collecting network traffic data on-demand according to an embodiment of the present disclosure.

FIG. 8 is a block diagram schematically illustrating an exemplary computing device that may be used to implement the systems and methods described in this disclosure.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing components of embodiments of the present disclosure, reference numerals such as first, second, i), ii), and a), b) may be used. These numerals are only used to distinguish the components from other components, and the nature, sequence, or order of the components is not limited by the numerals. In the specification, when a part “includes” or “comprises” a component, unless there is an explicit description to the contrary, the part may further include other components rather than excluding the other components.

The detailed description set forth below in connection with the appended drawings is intended to describe exemplary embodiments of the disclosure and is not intended to represent the only embodiment in which the disclosure may be practiced.

The data consumer herein may be the same as the user or may be different from the user, and is not limited to a specific form.

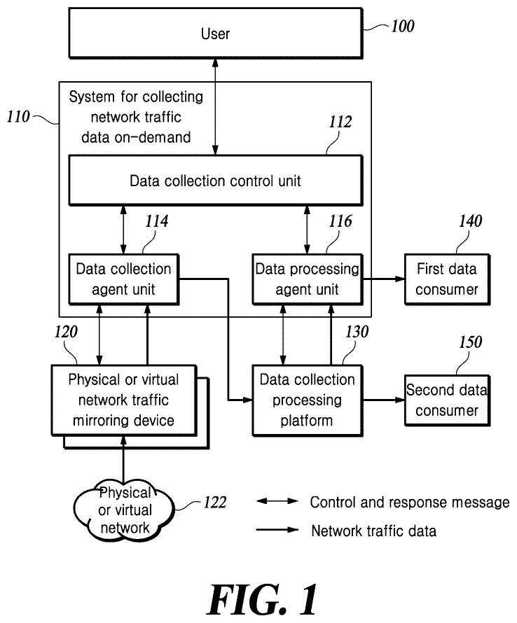

FIG. 1 is a structural diagram of a system for collecting network traffic data on-demand according to an embodiment of the present disclosure.

The system for collecting network traffic data on-demand 110 is a single device or a system in which several devices are combined to perform the function of receiving a collection order request for network traffic data from a user, collecting traffic data of a target physical network or traffic data of a virtual network, performing data processing required by the user, and then storing or transmitting the processed network traffic data to a data consumer required by the user.

The user is a terminal, a device, a system, or software that uses a system for collecting network traffic data on-demand to request a collection order for network traffic data.

The data consumer is a terminal, a device, a system or software that receives network traffic data collected and processed by the system for collecting network traffic data on-demand.

Physical network traffic data refers to data of packets passing through a network composed of actual physical switches.

Virtual network traffic data refers to data of packets that a virtual machine transmits and receives or data of packets a container transmits and receives within a virtual machine execution platform (e.g., OpenStack) or a container execution platform (e.g., Kubernetes).

The network traffic data processed by the system for collecting network traffic data on-demand refers to some or all of the attribute information of the collected network traffic data and statistical information extracted from the collected network traffic data.

The system for collecting network traffic data on-demand 110 includes, but is not limited to, a data collection control unit 112, a data collection agent unit 114, and a data processing agent unit 116.

The data collection control unit 112, the data collection agent unit 114, and the data processing agent unit 116 may be in one physical device or may be separated from each other in different physical devices.

The data collection control unit 112 receives a collection order request from the user 100 and controls the data collection agent unit 114 and the data processing agent unit 116 to process the collection order.

The data collection agent unit 114 controls one or more network traffic mirroring devices connected to the physical network or the virtual network, receives the mirrored network traffic, generates network traffic data as requested by the user, and transmits the network traffic data to the data collection processing platform.

Here, the data collection agent unit 114 may include one or more data collection agents.

The different data collection agents may be on one physical device or may be on different physical devices.

Each data collection agent may collect network traffic from a physical (or virtual network) traffic mirroring device 120 connected to a corresponding physical (or virtual) network 122.

The data processing agent unit 116 controls the data collection processing platform 130 to store the collected network traffic data, perform the data processing task required by the user 100, and transmit the processed data to a data consumer (e.g., the first data consumer 140) designated by the user 100.

The data processing agent unit may include one or more data processing agents.

The different data processing agents may be on one physical device or may be on different physical devices.

The data processing agent may control the data collection processing platform to perform a processing task required by the user on the collected network traffic data and then transmit the processed data to the data user.

The processing tasks required by the user may include: extracting statistical information from the network traffic data; changing a format of the data; and manipulating content of the data.

Alternatively, the data processing agent may read the network traffic data from the data collection processing platform according to a request of the user, perform the user-specified processing task directly, and then transmit the processed data to the data user.

Outside of the system for collecting network traffic data on-demand 110, there are a physical or virtual network traffic mirroring device 120 and a data collection processing platform 130.

The data collection processing platform 130 is a system (e.g., Kafka) capable of storing data streams, performing processing tasks to modify the contents of the data, and transmitting the data to data consumers using various protocols. The data processing agent unit 116 uses a control API (application program interface) provided by the data collection processing platform 130 to control tasks required by the user.

The data collection processing platform 130 receives and stores network traffic data from the data collection agent unit 114 and the data processing agent unit 116, performs a processing task for changing the network traffic data to network traffic data to reflect the user's requirements, and transmits the processed data to the user using a predetermined protocol.

Upon receiving the control signal from the data collection agent unit 114, the physical or virtual network traffic mirroring device 120 obtains network traffic data via the physical or virtual networks 122.

The first data consumer 140 and the second data consumer 150 may be the same as the user 100 or may be different.

The first data consumer 140 and the second data consumer 150 may be the same or different from the user.

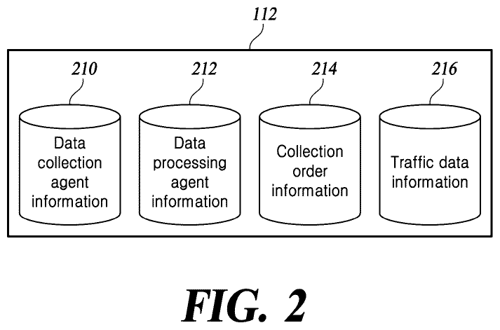

FIG. 2 illustrates an example of information managed by a data collection control unit of a system for collecting network traffic data on-demand according to an embodiment of the present disclosure.

The data collection control unit 112 manages information such as, but not limited to, data collection agent information 210, data processing agent information 212, collection order information 214, and traffic data information 216.

The data collection agent information 210 includes basic information of a data collection agent, its status information, and a list of collection orders currently being handled by the agent.

The basic information of the data collection agent includes a data collection agent ID, a data collection agent type (e.g., physical, or virtual), a data collection agent location, a uniform resource locator (URL), and the like.

The status information of the data collection agent includes, for example, offline, standby, running, error, and the like.

The list of collection orders currently handled by the data collection agent may include a collection order ID, target filter, data collection processing platform address, data collection control unit callback address, and a collection data information list.

Here, The collection data information list includes a collection data ID, collection data type, attribute information of the collection target, topic information within the data collection processing platform, the number of collected data blocks, the number of collected data records., and the like.

The data processing agent information 212 includes basic information of a data processing agent, status information of the data processing agent, a collection order information list being processed by the data processing agent, and the like.

The basic information of the data processing agent includes a data processing agent ID, a data processing agent type (e.g., HDFS, MySQL, ElasticEngine, Kafka), a data processing agent URL, a data collection processing platform address, and the like.

The status information of the data processing agent includes, for example, offline, standby, running, error, and the like.

The collection order information list being processed by the data processing agent includes a collection order ID, data consumer information (e.g., a data consumer URL, data consumer access information), a data collection control unit callback address, a collection data information list being processed, and the like.

The collection data information list being processed includes a collection data ID, a processed data format (e.g., avro (data serialization system), parquet (column-based data storage format), csv (simplest text-based format for storing data)), data collection processing platform topic information of the collection data, the number of processed data blocks, the number of processed data records, and the like.

The collection order information 214 includes a collection order ID, user requirement information about the collection order, a list of collection information for each collection data, a list of processing information for each data processing agent per collection data, status information of the collection order, and the like.

The user requirement information for the collection order includes a user ID, a request collection start time, a request collection end time, a data collection agent request information list, a data processing agent request information list, and the like.

The data collection agent request information list includes a data collection agent ID, a collection target filter (e.g., for collecting only traffic with specific attribute values), data generation interval per unit time, a collection data information list, collection target information if the agent is a virtual network data collection agent, and the like.

The collection data information list includes collection data types (e.g., flow data, flow unit time data, and packet data), collection target attribute information, which refers to the attributes selected for collection among the data-type-specific attributes, and the like.

For the virtual network data collection agent, the collection target information includes a name of a collection target virtual machine or container execution unit (e.g., a Kubernetes pod), collection target name space information, and the like.

The data processing agent request information list includes a data processing agent ID, a processing data format, data consumer information (e.g., a data consumer URL, data consumer access information), and the like.

The list of collection information for each collection data includes a data ID, a data collection agent ID, an actual collection start time, an actual collection end time, a data collection processing platform address, topic information of the collected data in the platform, the number of collected data blocks, the number of collected data records, and the like.

The processing information list per data processing agent for each collected data item includes a data ID, data processing agent ID, actual processing start and end times, topic information of the collected data in the data collection processing platform, the number of processed data blocks, the number of processed data records, and the like.

The status information of the collection order may include, for example: collection scheduled, collecting, awaiting collection agent termination, awaiting processing agent termination, successful collection completion, collection terminated by user, various error states, and the like.

The traffic data information 216 includes basic information of the collected traffic data, a list of processing information for each data processing agent, and the like.

The basic information of the collected traffic data includes a data ID, collection order ID, collection data type, collection start and end times, data schema information, data collection agent ID, the number of collected data blocks, the number of collected data records, and the like.

The processing information list for each data processing agent of the collected traffic data includes a data processing agent ID, processing start and end times, data consumer information (e.g., URL, access information), processing data format (e.g., Avro, Parquet, CSV), the number of processed data blocks and records, processing data schema information, and the like.

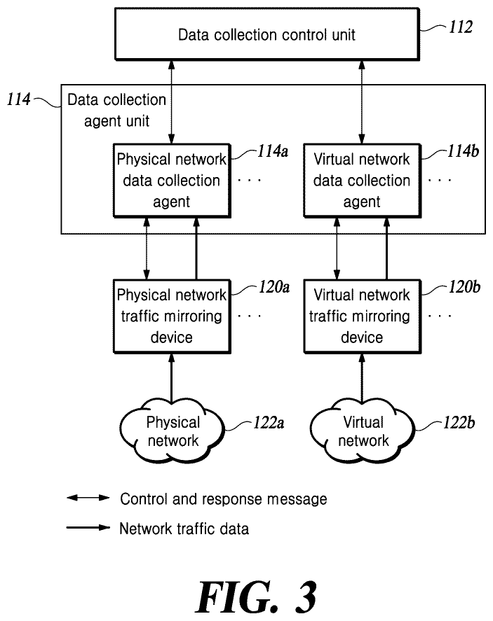

FIG. 3 is a diagram illustrating a configuration of a data collection agent unit of a system for collecting network traffic data on-demand according to an embodiment of the present disclosure.

The data collection agent unit 114 may include one or more data collection agents.

Each data collection agent represents a physical network data collection agent 114a or a virtual network data collection agent 114b.

The physical network data collection agent 114a may control the physical network traffic mirroring device 120a, which is connected to the physical network 122a, to collect network traffic.

The physical network traffic mirroring device 120a may be a switch or tap device that supports traffic mirroring. Alternatively, the physical network traffic mirroring device 120a may be a network traffic capture device connected to a switch or tap device.

The physical network data collection agent 114a may use a protocol provided by the physical network traffic mirroring device 120a to receive network traffic. Alternatively, an operator may manually configure the mirroring device to transmit network traffic to the physical network data collection agent 114a.

The virtual network data collection agent 114b may control the virtual network traffic mirroring device 120b connected to the virtual network 122b to collect network traffic from the virtual network traffic mirroring device 120b.

The virtual network traffic mirroring device 120b may be a virtual switch or a separate software unit that supports traffic mirroring within a virtual machine execution platform (e.g., OpenStack) or a container execution platform (e.g., Kubernetes).

The virtual network data collection agent 114b may control traffic transmission using a protocol provided by the virtual machine execution platform to receive network traffic from the virtual network traffic mirroring device 120b. Alternatively, an operator may manually configure the virtual machine or container execution platform so that the virtual network traffic mirroring device 120b transmits traffic to the virtual network data collection agent 114b.

The data collection agents may be in one physical device or may be distributed across several physical devices.

One data collection agent may handle collection tasks for multiple collection orders concurrently. To this end, it maintains a list of active collection orders.

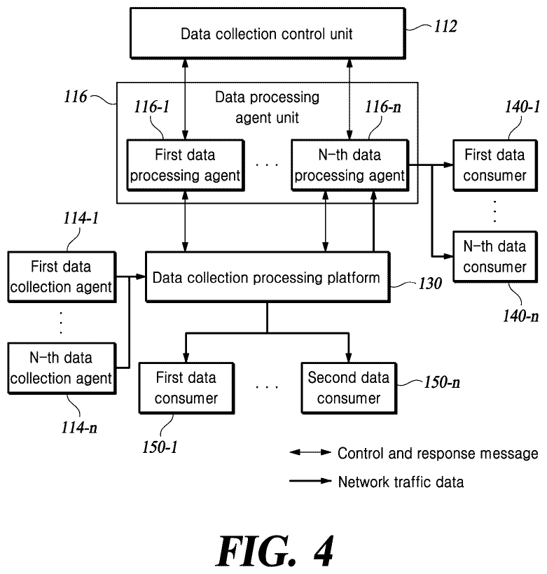

FIG. 4 is a diagram illustrating a configuration of a data processing agent unit of a system for collecting network traffic data on-demand according to an embodiment of the present disclosure.

The data processing agent unit 116 may include one or more data processing agents.

The data collection processing platform 130 stores network traffic received from the first data collection agent 114-1 to the n-th data collection agent 114-n.

The data processing agent may process the network traffic data stored in the data collection processing platform and transmit it to the data consumer in two ways.

In a first way, the data processing agent may control the data collection processing platform to transmit network traffic data processed directly by the platform 130 to the data consumers (e.g., the first data consumer 150-1 to the n-th data consumer 150-n).

At this time, if required by the collection order, the data collection processing platform 130 may perform processing tasks on the collected and stored network traffic data as requested by the user, and then transmit the processed data to the data consumers (e.g., the first data consumer 150-1 to the n-th data consumer 150-n).

In a second way, the data processing agent may read the stored network traffic data from the data collection processing platform 130, perform the user-specified processing tasks directly, and transmit the processed data to the data consumers (e.g., the first data consumer 140-1 to the n-th data consumer 140-n).

For example, if the data collection processing platform does not support the protocol used by the data consumer, the data processing agent may transmit the data using that protocol.

For another example, if the data collection processing platform does not support the required processing method, the data processing agents (e.g., the first data processing agent 116-1 to the n-th data processing agent 116-n) may read the network traffic data, perform the required processing, and transmit the processed data directly to the data consumers.

One data processing agent may simultaneously process multiple network traffic data streams received from one or more data collection agents. To this end, it manages a list of active collection orders.

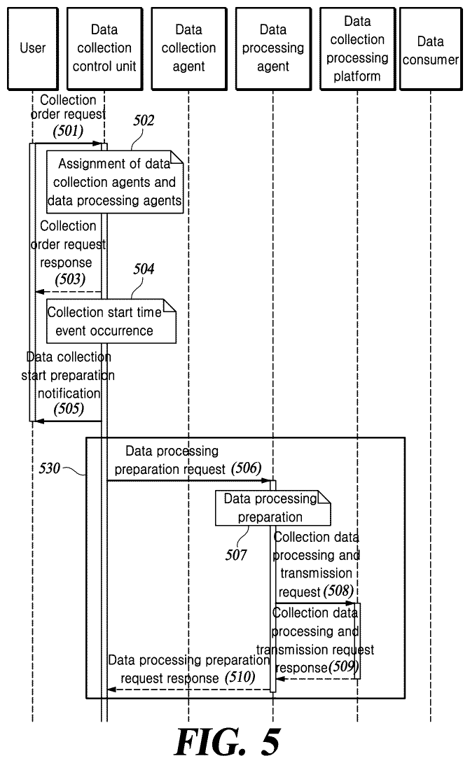

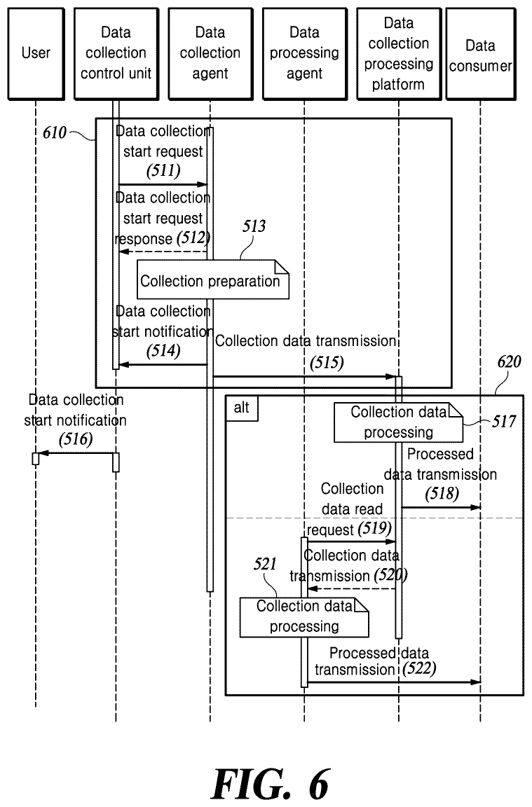

FIGS. 5 and 6 are flowcharts illustrating an on-demand data collection start procedure using a system for collecting network traffic data on-demand according to an embodiment of the present disclosure.

FIG. 6 is a continuation of FIG. 5.

In step 501, the data collection control unit may receive a collection order request message from a user. The collection order request message may include user requirement information on the collection order, and the like.

The user requirement information for the collection order may include a user ID, a request collection start time, a request collection end time, a data collection agent request information list, a data processing agent request information list, and the like.

The data collection agent request information list is a list of parameters to be used by one or more data collection agents, and may include a data collection agent ID, a collection target filter, a data generation interval per unit time, a collection data information list, information specific to virtual network data collection agents, such as collection target information, and the like.

The collection data information list may include a collection data type and collection target attribute information, and the like.

For a virtual network data collection agent, the collection target information may include a name of a collection target virtual machine or container execution unit (such as a Kubernetes pod), collection target namespace information, and the like.

The data processing agent request information list may include information for requesting data processing by one or more data processing agents, including a data processing agent ID, a processing data format, data consumer information, and the like.

In step 502, the data collection control unit verifies validity of the collection order requested by the user, and if the collection order is valid, allocates one or more data collection agents and one or more data processing agents to the collection order for a collection start time and a collection end time range included in the collection order. Further, the data collection control unit assigns a collection order ID to the collection order requested by the user, and respectively assigns a data ID to the collection data to be collected.

In step 503, the data collection control unit transmits a response message to the user regarding the collection order request. The collection order response message may include a collection order ID, user requirement information for the collection order, a list of collection information for each collection data, a list of processing information for each data processing agent per collection data, and the like.

The list of collection information for each collection data may include a data ID, a data collection agent ID, and the like.

The list of processing information for each data processing agent per collection data may include a data ID and a data processing agent ID, and the like.

In step 504, when the collection start time specified in the user's collection order arrives, the data collection control unit proceeds to step 505 and transmits a data collection start preparation notification message to the user.

The data collection start preparation notification message may include a collection order ID, status information of the collection order, and the like.

The operations included in 530 may be performed identically for all the data processing agents included in the collection order.

In step 506, the data collection control unit transmits a data processing preparation request message to each of the data processing agents included in the collection order. The data processing preparation request message may include a collection order ID, data consumer information, a data collection control unit callback address, a list of processing request information for each collection data, and the like.

The processing request information for each collection data may include a collection data ID, a collection data type, collection target attribute information, a processing data format, and the like.

Upon receiving the data processing preparation request message from the data collection control unit, the data processing agent proceeds to step 507 to verify the validity of the request. If valid, it prepares for data processing. For each piece of collected data, the data processing agent generates topic information for the data collection processing platform to store the data.

The data collection processing platform topic information may include an ID to be used by the data collection processing platform when storing and processing collection data, the data replication count, partition options, compression options, and the like.

In step 508, the data processing agent may transmit a request message to the data collection processing platform, asking it to receive, store, and process the data collected under the collection order and then transmit the processed data to the data consumer. Alternatively, if the data processing agent performs the processing and transmission directly, it may request the platform only to receive and store the data. The request message may include, for each collection data item, topic information for the data collection processing platform, the processing data format, processing data schema information, data consumer information, and the like.

In step 509, the data processing agent receives the collection data processing and transmission request response message from the data collection processing platform. The collection data processing and transmission request response message may include the success or failure result of the processing and transmission request, and the like.

When the data processing agent completes preparation, it proceeds to step 510 and sends a response message to the data collection control unit. This message may include, for each data item, the topic information for the data collection processing platform, the result of the preparation request (success or failure), and the like.

The data collection control unit waits for a data processing preparation request response from all the data processing agents included in the collection order. If no data processing preparation request response is received from all the data processing agents within a predetermined time, or if a response indicating that the data processing preparation request has failed is received from one or more data processing agents, the state of the collection order is changed to an error state, and a collection order error notification message is sent to the user.

When all data processing agents in the collection order return a success response, the data collection control unit proceeds to step 511 and transmits a data collection start request message to each data collection agent. This message may include a collection order ID, collection target filter, data generation interval per unit time, data collection processing platform address, callback address, virtual network target information (if applicable), and a list of collection request information for each data item, and the like.

The collection request information list for each collection data may include a collection data ID, a collection data type, collection target attribute information, data collection processing platform topic information of the collection data, and the like.

After validating the received data collection start request message, the data collection agent proceeds to step 512 and sends a response message to the data collection control unit. The response message may include the success or failure result of the request and, in case of failure, the cause.

In step 513, the data collection agent performs collection preparation.

Once collection preparation is completed and data collection begins, the data collection agent proceeds to step 514 and sends a data collection start notification message to the data collection control unit. This message may include a collection order ID, information for each collected data item, and the like.

The information for each collection data may include a collection data ID, a collection data type, collection target attribute information, data collection processing platform topic information of the collection data, the number of collected data blocks, the number of data records collected, and the like.

In step 515, the data collection agent transmits the collected data to the data collection processing platform using the platform's address and the topic information of the collection data.

Once the data collection control unit receives start notifications from all data collection agents, it proceeds to step 516 and sends a data collection start notification to the user. This message may include the collection order ID, user requirement information, a list of collection data items, a list of processing information for each data processing agent per collection data, the current status of the collection order, and the like.

In step 517, the data collection processing platform stores the network traffic data received from the data collection agent and performs the data processing as requested by the data processing agent. In step 518, it may transmit the processed data to the designated data consumer.

Alternatively, in step 519, the data processing agent sends a read request to the data collection processing platform to retrieve the collected network traffic data.

In step 520, after receiving the collected data from the data collection processing platform, the data processing agent proceeds to step 521 to perform the required data processing. Then, in step 522, it transmits the processed data to the designated data consumer.

In summary, the processing and transmission of the collected data may be performed either through steps 517 to 518, or through steps 519 to 522.

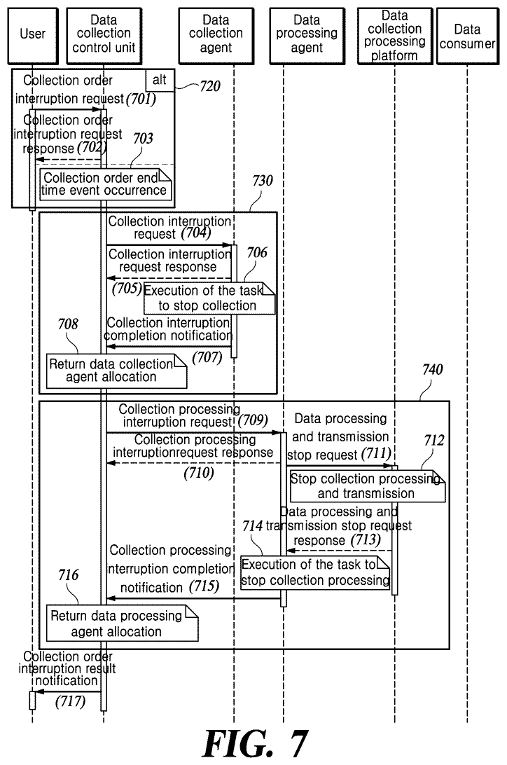

FIG. 7 is a flowchart illustrating an on-demand data collection interruption procedure using a system for collecting network traffic data on-demand according to an embodiment of the present disclosure.

Reference number 720 indicates two possible ways to initiate a collection order interruption. The interruption process may be carried out using either method.

The first process for initiating a collection order interruption includes step 701 and step 702.

The second process for initiating a collection order interruption includes step 703.

In step 701, the data collection control unit may receive a collection order interruption request message from the user, which may include a collection order ID and other related information.

In step 702, the data collection control unit checks the status of the requested collection order to determine whether it can be stopped, and sends a response message to the user. The response message may include the result (success or failure), if failed, the reason for the failure, and the like.

Alternatively, if the collection end time specified in the collection order request arrives, the data collection control unit may proceed to step 703 to automatically initiate the interruption procedure, even without an explicit request from the user.

In summary, the collection order interruption process may be performed through steps 701 and 702, or through step 703.

The operations included in 730 may be performed identically for all the data collection agents included in the collection order.

In step 704, the data collection control unit transmits a collection interruption request message to each of the data collection agents included in the collection order. The collection interruption request message may include a collection order ID, and the like.

In step 705, upon receiving the collection interruption request, the data collection agent verifies whether the request is valid and sends a response to the data collection control unit. The response may include the result (success or failure), if failed, the cause of the failure, and the like.

In step 706, when the data collection agent completes the interruption task, it proceeds to step 707 and sends a collection interruption completion notification to the data collection control unit. The message may include a collection order ID, a collection information list for each data item, and the like.

The collection information list for each collection data may include a data ID, a data collection agent ID, an actual collection start time, an actual collection end time, a data collection processing platform address, data collection processing platform topic information of the collected data, the number of collected data blocks, the number of data records collected, and the like.

In step 708, upon receiving the collection interruption completion notifications from all data collection agents, the data collection control unit deallocates the agents assigned for the collection time period.

The operations in reference number 740 are performed identically for all data processing agents included in the collection order.

After receiving collection interruption completion notifications from all data collection agents, the data collection control unit proceeds to step 709 and sends a collection processing interruption request to each data processing agent in the collection order. The request may include the collection order ID and related information.

In step 710, upon receiving the request, the data processing agent verifies whether it is valid and sends a response to the data collection control unit. The response may include the result (success or failure), if failed, the reason for failure, and the like.

In step 711, the data processing agent transmits a data processing and transmission stop request message to the data collection processing platform. The data processing and transmission stop request message may include data collection processing platform topic information for each collection data, data consumer information, and the like.

In step 712, the data collection processing platform stops the data processing and transmission.

In step 713, the data processing agent may receive a response from the data collection processing platform regarding the termination request. The response may include the result (success or failure), if failed, the reason for the failure, and the like.

If the data processing agent directly handles the processing of collected data and transmits it to the data consumer, it performs the collection processing interruption task in step 714.

Once the interruption task is completed, the data processing agent proceeds to step 715 and sends a collection processing interruption completion notification to the data collection control unit. This message may include the collection order ID, per-data processing information, and the like.

The processing information for each data processing agent per collection data may include a data ID, a data processing agent ID, an actual processing start time, an actual processing end time, data collection processing platform topic information of the collected data, the number of processed data blocks, the number of processed data records, and the like.

In step 716, after receiving interruption completion notifications from all data processing agents, the data collection control unit deallocates the agents assigned for the specified collection time range.

In step 717, the data collection control unit sends a collection interruption result notification to the user. The message may include the collection order ID, user requirement information, collection data information, processing information for data processing agent per collection data, the current status of the collection order, and the like.

The embodiments of the present disclosure may collect physical or virtual network traffic data on-demand for a user-specified period in a mixed physical and virtual network environment. They may extract and store only the data attribute or statistical information specified by the user, or perform user-defined data processing and transmit the result to data consumers.

In addition, a single collection order may be used to simultaneously collect network traffic data from one or more physical or virtual networks.

Further, the embodiments may simultaneously transmit network traffic data and/or statistical information collected in a single collection order to multiple data consumers of different types.

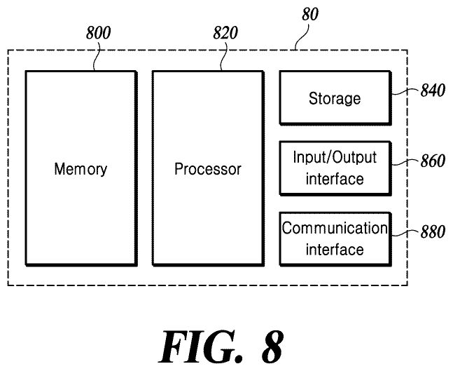

FIG. 8 is a block diagram schematically illustrating an exemplary computing device that may be used to implement the systems and methods described in this disclosure.

Computing device 80 may include some or all of the memory 800, processor 820, storage 840, input/output interface 860, and communication interface 880. Computing device 80 may structurally and/or functionally include at least a portion of the system for collecting network traffic data on-demand 110. Computing device 80 may be a stationary computing device such as a desktop computer, a server, as well as a mobile computing device, such as a laptop computer, a smartphone. Computing device 80 may be implemented with any specialized hardware accelerator capable of processing operations on an artificial intelligence model in an efficient manner. For example, the computing device 80 may be implemented as a graphics processing unit (GPU), a tensor processing unit (TPU), and a neural processing unit (NPU).

The memory 800 may store a program that causes the processor 820 to perform a method or an operation according to various embodiments of the present disclosure. For example, the program may include a plurality of instructions executable by the processor 820, and the method shown in FIG. 7 may be performed by the plurality of instructions being executed by the processor 810.

The memory 800 may be a single memory or a plurality of memories. In this case, information required for performing the methods or operations according to various embodiments of the present disclosure may be stored in a single memory or may be separately stored in a plurality of memories. When the memory 800 is configured with a plurality of memories, the plurality of memories may be physically separated.

The memory 800 may include at least one of a volatile memory and a non-volatile memory. The volatile memory includes a static random-access memory (SRAM) or a dynamic random-access memory (DRAM) and the like, and the non-volatile memory includes a flash memory and the like.

The processor 820 may include at least one core capable of executing at least one instruction. The processor 820 may execute instructions stored in the memory 800. The processor 820 may be a single processor or a plurality of processors.

The storage 840 maintains stored data even when power supplied to the computing device 80 is interrupted. For example, the storage 840 may include a non-volatile memory, and may include a storage medium such as a magnetic tape, an optical disc, or a magnetic disk.

The program stored in the storage 840 may be loaded into the memory 800 before being executed by the processor 820. The storage 840 may store a file written in a program language, and a program generated by a compiler from the file may be loaded into the memory 800. The storage 840 may store data to be processed by the processor 820 and/or data processed by the processors 820.

The input/output interface 860 may include an input device such as a keyboard and a mouse, and may include an output device such as a display device and a printer. The user may trigger execution of a program by the processor 820 and/or check a processing result of the processor 820 through the input/output interface 860.

The communication interface 880 may provide access to an external network. For example, the computing device 80 may communicate with other devices (e.g., camera 20) via communication interface 880.

Each component of the system or method according to the present disclosure may be implemented by hardware or software, or may be implemented by a combination of hardware and software. In addition, a function of each component may be implemented in software, and a microprocessor may be implemented to execute a function of the software corresponding to each component.

At least some of the components described in the exemplary embodiments of the present disclosure may be implemented as hardware components including at least one or a combination of a digital signal processor (DSP), a processor, a network control unit, an application-specific IC (ASIC), a programmable logic device (e.g., FPGA), and other electronic devices. In addition, at least some functions or processes described in the exemplary embodiments may be implemented in software, and the software may be stored in a recording medium. At least some components, functions, and processes described in the exemplary embodiments of the present disclosure may be implemented by a combination of hardware and software.

The method according to the exemplary embodiments of the present disclosure may be written as a computer-executable program, and may also be implemented as various recording media such as a magnetic storage medium, an optical reading medium, and a digital storage medium.

Implementations of the various techniques described herein may be implemented in digital electronic circuitry, or in computer hardware, firmware, software, or in combinations thereof. Implementations may be implemented as a computer program product, i.e., a computer program tangibly embodied in an information carrier, for example, in a machine-readable storage device (computer-readable medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and it can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Processors suitable for the processing of a computer program include, by way of example, both general and special purpose microprocessors, and any one or more processors of any kind of digital computer. Generally, a processor will receive instructions and data from a read-only memory or a random-access memory or both. Elements of a computer may include at least one processor for executing instructions and one or more memory devices for storing instructions and data. Generally, a computer may include one or more mass storage devices for storing data, such as magnetic disks, magneto-optical disks, or optical disks, or may be coupled to receive data from, transmit data to, or both. Information carriers suitable for embodying computer program instructions and data include, by way of example, semiconductor memory devices, magnetic media such as hard disks, floppy disks, and magnetic tape, optical media such as Compact Disk Read Only Memory (CD-ROM), Digital Video Disk (DVD), Magneto-Optical Media such as Floptical Disk, Read Only Memory (ROM), Random Access Memory (RAM), flash memory, Erasable Programmable ROM (EPROM), Electrically Erasable Programmable ROM (EEPROM), and the like. The processor and the memory can be supplemented by, or incorporated in, special purpose logic circuitry.

The processor may perform an operating system and a software application performed on the operating system. Further, the processor device may access, store, manipulate, process, and generate data in response to execution of the software. For ease of understanding, a processor device may be described as being used singly, but a person skilled in the art may understand that the processor device may include a plurality of processing elements and/or a plurality of types of processing elements. For example, the processor device may include a plurality of processors or one processor and one network control unit. Other processing configurations are also possible, such as parallel processors.

Moreover, non-transitory computer-readable media can be any available media that can be accessed by a computer and includes both computer storage media and transmission media.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described as operating in certain combinations and even initially claimed as such, one or more features from a claimed combination can in some cases be excised from the combination, and the claimed combination may be modified to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain cases, multitasking and parallel processing may be advantageous. Moreover, the separation of various device components in the embodiments described above should not be understood as requiring such separation in all embodiments, and it should be understood that the described program components and devices can generally be integrated together in a single software product or packaged into multiple software products.

Meanwhile, it should be noted that the embodiments of the present disclosure disclosed in the specification and the drawings are merely specific examples for facilitating understanding, and are not intended to limit the scope of the present disclosure. It is obvious to a person skilled in the art that other variations based on the technical idea of the present invention can be implemented in addition to the embodiments disclosed herein.

The protection scope of the present embodiment is to be construed according to the following claims, and all technical ideas within the scope equivalent thereto are construed as being included in the scope of rights of the present embodiment.

What is claimed is:

1. A method for collecting network traffic data on-demand, comprising:
transmitting, by a data collection control unit, a collection order request of a user to a data collection agent unit and a data processing agent unit;
transmitting, by the data collection agent unit, a first control signal to a network traffic mirroring device in accordance with the collection order request, and receiving first network traffic data from the network traffic mirroring device connected to a physical network or a virtual network;
transmitting, by the data collection agent unit, the first network traffic data to a data collection processing platform; and
transmitting, by the data processing agent unit, a second control signal to the data collection processing platform in accordance with the collection order request,
wherein the user receives second network traffic data that meets the collection order request from the data processing agent unit or the data collection processing platform, and
wherein the collection order request includes collection period information desired by the user, and data attribute information and statistical information specified by the user.

2. The method of claim 1, wherein the data collection processing platform is configured to: upon receiving the second control signal from the data processing agent unit, process the stored first network traffic data to generate second network traffic data that meets the collection order request, and directly transmit the generated second network traffic data to the user.

3. The method of claim 1, wherein the data processing agent unit is configured to read the first network traffic data stored in the data collection processing platform according to the collection order request, perform a data processing task on the read first network traffic data based on the collection order request to generate the second network traffic data that meets the collection order request, and transmit the generated second network traffic data to the user.

4. The method of claim 1, wherein the second network traffic data includes at least one of:
(a) part or all of the attribute information of the first network traffic data; and
(b) statistical information extracted from the first network traffic data.

5. The method of claim 3, wherein the data processing task includes at least one of:
(a) extracting statistical information from the read first network traffic data;
(b) changing the format of the read first network traffic data; and
(c) manipulating the content of the read first network traffic data.

6. The method of claim 1, wherein the data collection processing platform is configured to:
receive and store first network traffic data from the data collection agent unit;
perform a processing task to convert the first network traffic data into second network traffic data; and
transmit the second network traffic data to the user using a predetermined protocol.

7. The method of claim 1, wherein the data collection agent unit comprises one or more data collection agents,
wherein the one or more data collection agents are configured on a single physical device or across multiple physical devices, and
wherein the data processing agent unit comprises one or more data processing agents, and the one or more data processing agents are configured on a single physical device or across multiple physical devices.

8. The method of claim 1, wherein information of the collection order includes at least one of:
(a) a collection order ID;
(b) user requirement information for the collection order;
(c) a list of collection information for each collection data;
(d) a list of processing information for each data processing agent per collection data; and
(e) status information of the collection order;
and wherein the user requirement information includes at least one of:
(i) a user ID;
(ii) a requested collection start time;
(iii) a requested collection end time;
(iv) a data collection agent request information list; and
(v) a data processing agent request information list.

9. The method of claim 8, wherein:
(a) the list of collection information for each collection data includes at least one of:
(i) a collection data type; and
(ii) collection target attribute information;
(b) the data collection agent request information list includes at least one of:
(i) a data collection agent ID;
(ii) a collection target filter;
(iii) a unit time data generation cycle;
(iv) a collection data information list; and
(v) collection target information, if the data collection agent is a virtual network data collection agent;
(c) the collection target information, if the data collection agent is a virtual network data collection agent, includes at least one of:
(i) a name of a collection target virtual machine or container execution unit; and
(ii) collection target namespace information; and
(d) the data processing agent request information list represents a list of processing items for one or more data processing agents, and includes at least one of:
(i) a data processing agent ID;
(ii) a processing data format; and
(iii) data consumer information.

10. The method of claim 1, wherein the network traffic mirroring device comprises at least one of:
(a) a physical network traffic mirroring device, which includes a network traffic capture device connected to a switch or a tap device; and
(b) a virtual network traffic mirroring device, which includes a virtual switch or a software unit that supports traffic mirroring within a virtual machine execution platform or a container execution platform.

11. A system for collecting network traffic data on-demand, comprising:
a data collection control unit configured to transmit a collection order request of a user to a data collection agent unit and a data processing agent unit;
a data collection agent unit configured to transmit a first control signal to a network traffic mirroring device according to the collection order request, receive first network traffic data from the network traffic mirroring device connected to a physical network or a virtual network, and transmit the first network traffic data to a data collection processing platform;
a data processing agent unit configured to transmit a second control signal to the data collection processing platform according to the collection order request;
wherein the user receives second network traffic data that satisfies the collection order request from the data processing agent unit or the data collection processing platform; and
wherein the collection order request includes collection period information desired by the user, and data attribute information and statistical information specified by the user.

12. The system of claim 11, wherein the data collection processing platform is configured to, upon receiving the second control signal from the data processing agent unit:
process stored first network traffic data to generate second network traffic data that meets the collection order request; and
directly transmit the generated second network traffic data to the user.

13. The system of claim 11, wherein the data processing agent unit is configured to:
read first network traffic data stored in the data collection processing platform based on the collection order request;
perform a data processing task on the read first network traffic data to generate second network traffic data that meets the collection order request; and
transmit the generated second network traffic data to the user.

14. The system of claim 11, wherein the second network traffic data comprises at least one of:
(a) part or all of the attribute information of the first network traffic data; and
(b) statistical information extracted from the first network traffic data.

15. The system of claim 13, wherein the data processing task comprises at least one of:
(a) extracting statistical information from the read first network traffic data;
(b) changing the format of the read first network traffic data; and
(c) manipulating the content of the read first network traffic data.

16. The system of claim 11, wherein the data collection processing platform is configured to:
receive and store first network traffic data from the data collection agent unit and the data processing agent unit;
perform a processing task to convert the first network traffic data into second network traffic data; and
transmit the second network traffic data to the user using a predetermined protocol.

17. The system of claim 11, wherein the data collection agent unit comprises one or more data collection agents, which are configured on a single physical device or distributed across multiple physical devices, and
wherein the data processing agent unit comprises one or more data processing agents, which are configured on a single physical device or distributed across multiple physical devices.

18. The system of claim 11, wherein the collection order information comprises at least one of:
(a) a collection order ID;
(b) user requirement information for the collection order;
(c) a list of collection information for each collection data;
(d) a list of processing information for each data processing agent per collection data; and
(e) status information of the collection order;
and wherein the user requirement information comprises at least one of:
(i) a user ID;
(ii) a requested collection start time;
(iii) a requested collection end time;
(iv) a data collection agent request information list; and
(v) a data processing agent request information list.

19. The system of claim 18, wherein:
(a) the list of collection information for each collection data includes at least one of:
(i) a collection data type; and
(ii) collection target attribute information;
(b) the data collection agent request information list includes at least one of:
(i) a data collection agent ID;
(ii) a collection target filter;
(iii) a unit time data generation cycle;
(iv) a collection data information list; and
(v) collection target information, if the data collection agent is a virtual network data collection agent;
(c) the collection target information, if the data collection agent is a virtual network data collection agent, includes at least one of:
(i) a name of a collection target virtual machine or container execution unit; and
(ii) collection target namespace information;
(d) the data processing agent request information list represents a list of processing items for one or more data processing agents, and includes at least one of:
(i) a data processing agent ID;
(ii) a processing data format; and
(iii) data consumer information.

20. A method for collecting network traffic data on-demand, comprising:
transmitting, by a data collection control unit, a collection order request from a user to a data collection agent unit and a data processing agent unit;
transmitting, by the data collection agent unit, a first control signal to a network traffic mirroring device according to the collection order request, and receiving first network traffic data from the network traffic mirroring device connected to a physical network or a virtual network;
transmitting, by the data collection agent unit, the first network traffic data to a data collection processing platform;
transmitting, by the data processing agent unit, a second control signal to the data collection processing platform according to the collection order request;
wherein one or more data consumers other than the user receive second network traffic data that satisfies the collection order request from the data processing agent unit or the data collection processing platform; and
wherein the collection order request includes data consumer information, a collection period desired by the user, and data attribute information and statistical information specified by the user.
